(19) United States
(12) Patent Application Publication
(10) Pub. No.: US 2011/0267353 A1
(43) Pub. Date: Nov. 3, 2011

(54) Method of Displaying an Object Having a Predetermined Information Content on a Touch Screen

(76) Inventor: Fredrik Johansson, Malmo (SE)

(21) Appl. No.: 13/090,900

(22) Filed: Apr. 20, 2011

Related U.S. Application Data
(60) Provisional application No. 61/333,057, filed on May 10, 2010.

(30) Foreign Application Priority Data
Apr. 26, 2010 (EP) 10 004 407.2

(51) Int. Cl. G06T 11/20

(52) U.S. Cl. 345/440

(57) ABSTRACT

A method for displaying an object having a predetermined information content on a touch screen is provided. According to the method, a touch pattern of a user touching the touch screen (is detected, and a shape from a predetermined set of shapes is automatically selected based on the touch pattern. Furthermore, the object is automatically adapted to the selected shape, and the adapted object is displayed on the touch screen at a position where the touch pattern was detected.

### CROSS REFERENCE TO RELATED APPLICATIONS

This application claims priority from U.S. Provisional Application Ser. No. 61/333,057, filed May 10, 2010, and from European Patent Application No. EP 10004407.2, filed Apr. 26, 2010, the disclosures of which are incorporated herein in their entirety.

### FIELD OF THE INVENTION

This invention relates to a method and a device for displaying an object having a predetermined information content on a touch screen.

### BACKGROUND OF THE INVENTION

With the growing computing performance and display capabilities of mobile devices, for example mobile phones, personal digital assistants and mobile computers, a growing number of applications can be performed on these mobile devices. One of these applications is for example creating a layout of a page, for example for an email, a document, a report, a photo album or an internet page. Typically, the layout of such a page comprises several different objects, for example text, pictures, a video or an icon representing another object, for example a sound, which have to be arranged on the page. In commonly used methods such an arrangement or layouting is performed for example by first selecting an object, for example adding an image or a text, and then adjusting and positioning this object and its layout properties. However, it is difficult to create advanced visual layouts on a small screen of a mobile device, especially with a use of a finger on a touch screen of the mobile device.

Therefore, it is an object of the present invention to provide an improved and more suitable method for creating layouts on a touch screen, especially on a small screen of a mobile device.

### SUMMARY OF THE INVENTION

According to the present invention, this object is achieved by a method for displaying an object having a predetermined information content on the touch screen as defined in claim 1 and a device as defined in claim 9. The dependent claims defined preferred and advantageous embodiments of the invention.

According to an aspect of the present invention, a method for displaying an object on a touch screen is provided. The object is an object having a predetermined information content which has to be displayed on the touch screen. According to the method a touch pattern of a user touching the touch screen is detected and based on the detected touch pattern a shape from a predetermined set of shapes is automatically selected. The object to be displayed is adapted automatically to the selected shape and the adapted object having the selected shape is displayed on the touch screen at a position where the touch pattern was detected.

Traditionally, an object to be arranged on a screen, for example a picture or a text, is first selected, then displayed on the screen, and then arranged according to the desired layout by the user, for example by resizing, trimming, reshaping or rotating the object. According to the above-described method, layouting is performed in a reversed approach by enabling the user to first select the coarse shape and position of the object to be displayed. Then, based on the touch pattern of the coarse shape an accurate shape, for example a circle, a rectangle or a square, is automatically selected. Then, the object to be displayed is automatically adapted to the selected shape and positioned on the touch screen at the position where the touch pattern was detected. This simplifies the layout process significantly as the user just has to provide the coarse shape for the object and the object is then automatically adapted and displayed according to this coarse specification.

According to an embodiment, the step of automatically selecting the shape from the predetermined set of shapes is performed by automatically selecting the shape from the predetermined set of shapes based on a best matching between the shape and the touch pattern. Therefore, different predetermined shapes can be used and can be intuitively accessed by the user.

According to another embodiment, the shape is automatically selected when a touch of the touch screen by the user is no longer detected. This may help to simplify the work flow of the layout process significantly. When the user wants to display an object on the touch screen, the user simply touches the screen and describes by moving a finger on the touch screen the coarse layout of the object to be displayed. Then the user lifts the finger from the touch screen and based on the previously made touch pattern a desired shape is automatically selected from the predetermined set of shapes. Furthermore, a selecting box providing a selection for the object to be displayed in the automatically selected shape may be opened automatically to give the user the opportunity to select the object for the previously described shape. Then the selected object is automatically adapted to the selected shape and displayed on the touch screen as described above.

According to another embodiment, when adapting the object to the selected shape, the selected shape is adapted to a size and an orientation according to the touch pattern and the adapted shape is automatically displayed as a placeholder having the adapted shape on the touch screen at the position where the touch pattern was detected. The object to be displayed is then adapted to the shape. Typically for a layout, only a little number of basic shapes are necessary. Therefore, the predetermined set of shapes may comprise for example a square, a rectangle, a circle, a polygon, and a rectangular polygon. However, each of these shapes may be varied in size and rotation. Therefore, the basic shapes are automatically adapted to the size and orientation according to the touch pattern provided by the user. Therefore, a lot of different layouts can be designed by the user and only a few basic shapes have to be provided and recognized. By displaying the automatically adapted shape as a place holder on the touch screen to the user, the user gets a direct feedback of the designed shape and may redraw the shape, resize the shape, or change the orientation of the shape before selecting and automatically adapting the object to be displayed to the adapted shape.

According to an embodiment, the object is automatically adapted to the adapted shape such that the object is displayed within the placeholder on the touch screen. This may comprise further steps, for example resizing the object, rotating the object or trimming the object.

According to an embodiment, a type of the object is selected by the user from a plurality of available object types. Furthermore, the information content of the object may be selected by the user from a plurality of available information contents. The type of the object may comprise for example a text, a picture, a video or a sound. The sound may be represented by an icon to be displayed in the layout representing the sound. Therefore, a layout of a page, for example for an email, an internet page or a photo album, can be designed and layout very easy and a lot of different objects can be arranged.

According to another aspect of the present invention a device comprising a touch screen and a processing unit is provided. The touch screen is adapted to display an object having a predetermined information content on the touch screen and to detect a touch pattern of a user touching the touch screen. The processing unit is adapted to select automatically a shape from a predetermined set of shapes based on the touch pattern, to adapt automatically the object to the selected shape, and to display the adapted object having the selected shape on the touch screen at a position where the touch pattern was detected. The device may be adapted to perform the above-described method and comprises therefore the above-described advantages.

The device may be for example a mobile phone, a personal digital assistant, a mobile navigation system, a mobile media player or a mobile computer.

Although specific features described in the above summary and the following details description are described in connection with specific embodiments, it is to be understood that the features of the embodiments described can be combined with each other unless it is noted otherwise.

### BRIEF DESCRIPTION OF THE DRAWINGS

The invention will now be described in more detail with reference to the accompanying drawings.

FIGS. 1A-1D show an embodiment of a mobile device according to the present invention.

FIGS. 2A-2E show another embodiment of a mobile device according to the present invention.

FIGS. 3A-3E show a third embodiment of a mobile device according to the present invention.

FIGS. 4A-4C show yet another embodiment of a mobile device according to the present invention.

### DETAILED DESCRIPTION OF PREFERRED EMBODIMENTS

In the following, exemplary embodiments of the present invention will be described in detail. It is to be understood that the following description is given only for the purpose of illustrating the principles of the invention and is not to be taken in a limiting sense. Rather, the scope of the invention is defined only by the appended claims and not intended to be limited by the exemplary embodiments hereinafter.

It is to be understood that the features of the various exemplary embodiments described herein may be combined with each other unless specifically noted otherwise. Same reference signs in the various instances of the drawings refer to similar or identical components.

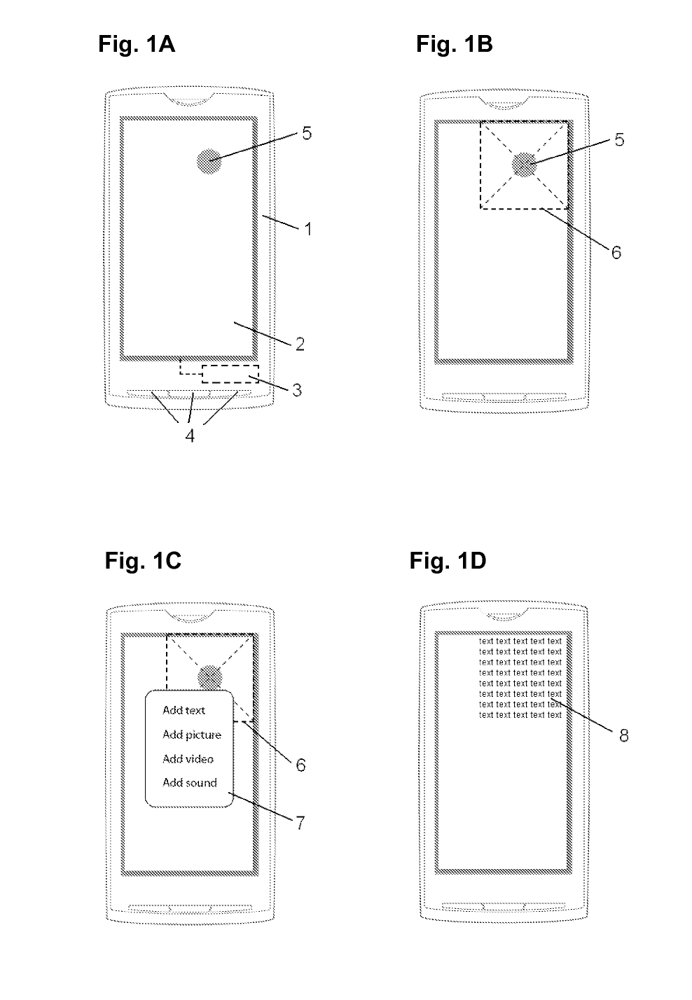

FIG. 1A shows a mobile device 1 comprising a touch screen 2 and a processing unit 3. The processing unit 3 is inside the mobile device 1 and therefore shown with dashed lines. The processing unit 3 is coupled to the touch screen 2. The mobile device 1 comprises furthermore some press buttons 4 and may comprise some more components or elements (not shown), for example a battery, a microphone, a loudspeaker, a radio frequency receiver and transmitter and so on. However, these additional components or elements are not shown to simplify matters.

The touch screen 2 is adapted to display text and graphics. Furthermore, the touch screen is adapted to detect a touch pattern of a user touching the touch screen 2. The user may touch the touch screen 2 with a finger of the user or a stylus, for example a pen. The touch screen 2 is coupled to the processing unit 3 and the processing unit 3 is adapted to receive the touch pattern detected by the touch screen 2 and to provide information to the touch screen 2 for displaying graphical or textual objects.

When the processing unit 3 is in a mode for designing a layout of a page, for example of a page of an email, a photo album or a report, the processing unit 3 displays initially for example a blank page on the touch screen 2. When the user wants to place and display an object on the page, the user simply has to touch the touch screen 2 and coarsely define a shape the object shall have on the page.

In case the user wants to add a square-shaped object, the user has to tap on the touch screen at a center point of the square and in response to this when the user no longer touches the screen, the processing unit 3 displays a default placeholder of a square with no rotation. This is shown in FIGS. 1A and 1B. In FIG. 1A the user touches the touch screen 2 at the touch position 5. After releasing the touch screen 2, for example by lifting the finger, the processing unit 3 analyzes the touch pattern which is in this case a simple touch at one point of the touch screen 2. In response to this single touch pattern, a predefined default shape of a square 6 is presented around the touching point 5 as shown in FIG. 1B. Then, as shown in FIG. 1C, a selection box 7 is presented to the user on the touch screen 2 giving the user the selection to add an object of a specific type, for example a text, a picture, a video or a sound. The selection box 7 may be automatically displayed after the square-shaped placeholder is displayed on the touch screen 2 or may be displayed in response to the user touching the placeholder square 6. In the embodiment shown in FIG. 1C the user selects for example “add text” and in another step (not shown) the user may enter a text or select an object containing text content stored in the mobile device 1. After selecting the text the processing unit 3 adapts the text to the shape of the square 6. Adapting the text to the shape 6 may for example comprise a resizing of the text or reformatting of the text. FIG. 1D shows the result of the adapted text 8 displayed on the touch screen 2.

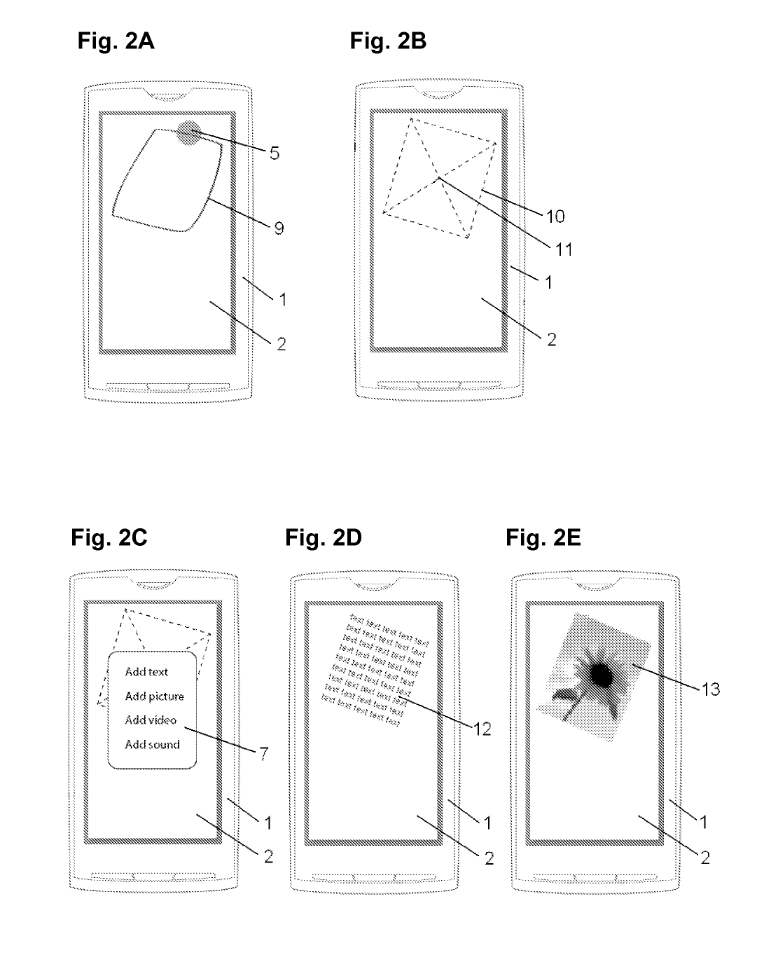

FIGS. 2A-2E show another embodiment of arranging an object on the touch screen 2. Starting from a blank page the user touches the touch screen 2 at touching point 5 and describes coarsely a circumferential line 9 of a rotated rectangle by moving the user's finger on the touch screen 2. After lifting the finger from the touch screen 2 the processing unit 3 analyzes the touch pattern 9 of the coarsely described rectangle 9 and automatically selects a shape from a predetermined set of shapes based on the touch pattern 9 and a best matching of the touch pattern 9 to one of the shapes from the predetermined set of shapes. The predetermined set of shapes may comprise for example a rectangle, a circle, a polygon and a rectangular polygon. In this case, a rectangle is identified. Furthermore, a rotation angle of the rectangle is identified. Additionally, a center point of the rectangle is automatically determined. In response, the processing unit 3 displays a placeholder 10 in form of a rotated rectangle around a center point 11. Then, as described in connection with FIG. 1C, in FIG. 2C a selection box is displayed to the user for selecting the type of object to be inserted into the placeholder 10. The user may for example select a text 12 content to be inserted into the placeholder 10. In this case, as shown in FIG. 2D, the text 12 is rotated according to the rotation angle of the shape 10. Furthermore, the text 12 may be adapted in size to match into the placeholder 10, or the placeholder 10 may be expanded automatically, e.g. at a bottom side, or it may be indicated to the user that the content is cropped so that the user can identify potential problems and resize the placeholder 10 manually. Alternatively, the user may select adding a picture 13 as the content to be inserted into the placeholder 10. FIG. 2E shows the result. The picture 13 is also rotated according to the rotation of the placeholder 10 and additionally the picture 13 is resized to fit into the shape 10. If necessary, the picture 13 is also trimmed to the size of the placeholder 10.

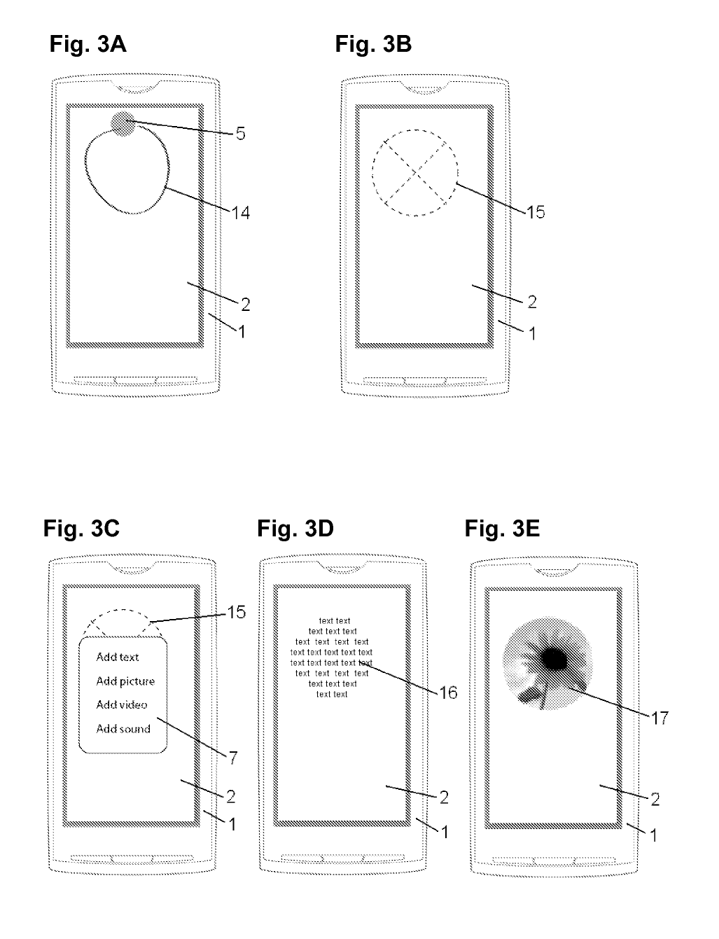

FIGS. 3A-3E show another example of another kind of shape for an object the user wants to display on the touch screen 2. As shown in FIG. 3A, the user draws coarsely a circle where the user wants to place an object in a circle form. Starting from touching point 5 the user describes coarsely a circle 14. The processing unit 3 automatically selects a circle shape 15 from the predetermined set of shapes and adapts the shape to the size and position of the coarsely drawn circle 14 from the user. The result is shown in FIG. 3B as a placeholder 15 having a circular shape. As described above in connection with FIG. 2C, the user may add a text, a picture, a video or a sound to the placeholder 15. In case the user adds a text 16 to the placeholder 15, the result is shown in FIG. 3D. The text 16 is rearranged such that the text 16 is displayed within the placeholder 15 on the touch screen 2. Therefore, a new word wrapping of the text 16 may be necessary, or the text 16 may be adapted to the placeholder 15 by other visual effects, for example a fish eye lens effect or other circular alignment effects. Alternatively, the user may select to add a picture 17 as shown in FIG. 3E. The picture 17 is automatically adapted by the processing unit 3 to the shape 15 such that the picture 17 is displayed within the placeholder 15 on the touch screen 2.

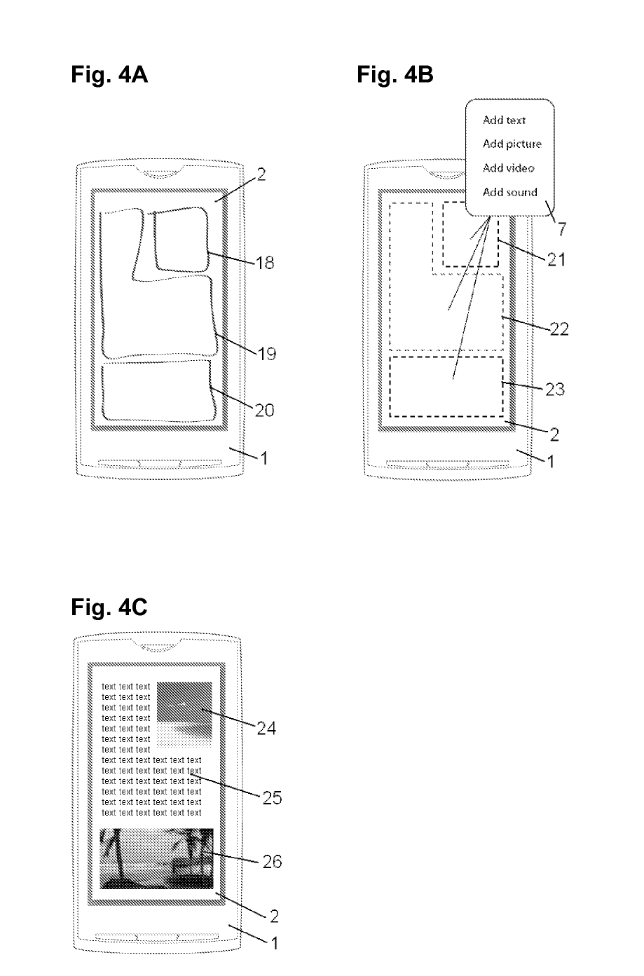

FIGS. 4A-4C show another example of adding objects to a layout on the touch screen 2. In this example, as shown in FIG. 4A, the user defines three layout elements coarsely as placeholders for three different objects. First, the user describes a rectangular 18, then the user describes a polygon 19, and then the user describes a rectangular 20. In response to each of the touching patterns the processing unit 3 selects an appropriate shape from a predetermined set of shapes, in this case a rectangular 21 corresponding to the user's rectangular 18, a polygon 22 corresponding to the user's polygon 19, and a rectangular 23 corresponding to the user's rectangular 20. The rectangulars 21 and 23 and the polygon 22 are adapted in size and position to the touching patterns 18-20 provided by the user and are displayed as placeholders 21-23 on the touch screen 2 as shown in FIG. 4B. Then objects are added to each of the placeholders 21-23. This may be accomplished by touching sequentially each of the placeholders 21-23 and selecting for each of the placeholders 21-23 a corresponding object, or the objects may be selected immediately after the user has coarsely defined the shape of each of the placeholders. After the objects have been added in step 4B, the objects are adapted automatically by the processing unit 3 to the placeholder shapes 21-23. FIG. 4C shows the result. A picture 24 was added to placeholder 21, a text 25 was added to placeholder 22, and another picture 26 was added to placeholder 23.

While exemplary embodiments have been described above, various modifications may be implemented in other embodiments. For example, further shapes in the predetermined set of shapes may be provided, for example a triangle and an ellipse.

Finally, it is to be understood that all the embodiments described above are considered to be comprised by the present invention as it is defined by the appended claims.

1. A method for displaying an object having a predetermined information content on a touch screen, the method comprising the steps of:
detecting a touch pattern of a user touching the touch screen,
automatically selecting a shape from a predetermined set of shapes based on the touch pattern,
automatically adapting the object to the selected shape, and
displaying the adapted object having the selected shape on the touch screen at a position where the touch pattern was detected.

2. The method according to claim 1, wherein the step of automatically selecting the shape from the predetermined set of shapes comprises automatically selecting the shape from the predetermined set of shapes based on a best matching between the shape and the touch pattern.

3. The method according to claim 1, wherein the shape is automatically selected when no longer a touch of the touch screen by the user is detected.

4. The method according to claim 1, wherein the step of adapting the object to the selected shape comprises:
automatically adapting the selected shape to a size and orientation according to the touch pattern,
automatically displaying a placeholder having the adapted shape on the touch screen at the position where the touch pattern was detected, and
adapting the object to be displayed to the adapted shape.

5. The method according to claim 4, wherein the object is automatically adapted to the adapted shape such that, in the step of displaying the object, the object is displayed within the placeholder on the touch screen.

6. The method according to claim 1, further comprising a step of selecting a type of the object and/or the information content of the object by the user from a plurality of available object types and information contents, respectively.

7. The method according to claim 6, wherein the type of the object comprises a type selected from the group comprising text, a picture, a video, and a sound.

8. The method according to claim 1, wherein the predetermined set of shapes comprises shapes selected from the group comprising a square, a rectangle, a circle, a polygon, and a rectangular polygon.

9. A device, comprising:
a touch screen adapted to display an object having a predetermined information content thereon and to detect a touch pattern of a user touching the touch screen, and
a processing unit adapted
to automatically select a shape from a predetermined set of shapes based on the touch pattern,
to automatically adapt the object to the selected shape, and
to display the adapted object having the selected shape on the touch screen at a position where the touch pattern was detected.

10. The device according to claim 9, wherein the device is adapted to perform the following
detecting a touch pattern of a user touching the touch screen,
automatically selecting a shape from a predetermined set of shapes based on the touch pattern,
automatically adapting the object to the selected shape, and
displaying the adapted object having the selected shape on the touch screen at a position where the touch pattern was detected.

11. The device according to claim 9, wherein the device comprises a device selected from the group comprising a mobile phone, a personal digital assistant, a mobile navigation system, a mobile media player, and a mobile computer.

12. The method according to claim 2, wherein the shape is automatically selected when no longer a touch of the touch screen by the user is detected.

13. The method according to 12, wherein the step of adapting the object to the selected shape comprises:
automatically adapting the selected shape to a size and orientation according to the touch pattern,
automatically displaying a placeholder having the adapted shape on the touch screen at the position where the touch pattern was detected, and
adapting the object to be displayed to the adapted shape.

14. The method according to claim 13, further comprising a step of selecting a type of the object and/or the information content of the object by the user from a plurality of available object types and information contents, respectively.

15. The method according to claim 14, wherein the type of the object comprises a type selected from the group comprising text, a picture, a video, and a sound.

16. The method according to claim 15, wherein the predetermined set of shapes comprises shapes selected from the group comprising a square, a rectangle, a circle, a polygon, and a rectangular polygon.

17. The method according to claim 4, further comprising a step of selecting a type of the object and/or the information content of the object by the user from a plurality of available object types and information contents, respectively.

18. The method according to claim 17, wherein the type of the object comprises a type selected from the group comprising text, a picture, a video, and a sound.

19. The method according to claim 4, wherein the predetermined set of shapes comprises shapes selected from the group comprising a square, a rectangle, a circle, a polygon, and a rectangular polygon.

20. The device according to claim 10, wherein the device comprises a device selected from the group comprising a mobile phone, a personal digital assistant, a mobile navigation system, a mobile media player, and a mobile computer.
